(19) United States
(12) Patent Application Publication
(10) Pub. No.: US 2010/0119810 A1
(43) Pub. Date: May 13, 2010

(54) COMPOSITIONALLY UNIFORM, MULTI-LAYER, GROUP VB, HYDROGEN TRANSPORT MEMBRANE

(75) Inventors: Kevin Krist, Palatine, IL (US); Shiguang Li, Mount Prospect, IL (US); David J. Schroeder, Aurora, IL (US); Chakravarthy Sishtla, Woodridge, IL (US); Estela T. Ong, Chicago, IL (US); Qinbai Fan, Chicago, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/268,636

(22) Filed: Nov. 11, 2008

(51) Int. Cl. B32B 3/26

(52) U.S. Cl. 428/315.9; 428/316.6

(57) ABSTRACT

A hydrogen-selective membrane material having a dense inner membrane layer composed of a Group VB alloy and no Pd disposed between two porous outer membrane support layers composed of the same Group VB alloy and no Pd or other noble metal, the amount of the Group VB alloy being greater than about 90 atomic % of each layer.

### BACKGROUND OF THE INVENTION

1. Field of the Invention

In one aspect, this invention relates to apparatuses for selective separation of molecular hydrogen from gaseous mixtures, such as synthesis gas, comprising said molecular hydrogen. In another aspect, this invention relates to hydrogen-selective membranes for separation of molecular hydrogen from gaseous mixtures comprising said molecular hydrogen. In another aspect, this invention relates to substantially compositionally uniform, non-palladium, Group VB alloy membrane structures comprising external support layers and a central, dense, membrane layer.

2. Description of Related Art

Many studies project that membranes may be critical to clean technologies that gasify coal and other carbonaceous materials to produce synthesis gases containing hydrogen. These studies project that, relative to conventional systems, membrane systems may reduce the cost of hydrogen by up to 25%, increase the yield of hydrogen per unit of carbonaceous material feed, and allow sequestration or utilization of a concentrated carbon dioxide stream. Conventional pressure-swing adsorption (PSA) separation of hydrogen requires re-pressurization of large amounts of gas and cooling of the gases to low temperatures and, thus, is not particularly attractive.

The cost reductions for hydrogen production are expected to come not only from improved membrane performance, but also from the integration of water-gas shift and reforming steps and the simplified processing of the non-permeate carbon dioxide stream. The carbon dioxide may be concentrated by condensation of the steam, reducing the system's environmental impact. In addition to coal, such membranes would enable more effective technologies for converting biomass, natural gas, and other hydrocarbon fuels in many chemical, refining, steel, and fuel cell and other power generation applications.

Efforts over 140 years have sought to use the ability of certain metals and alloys to transport hydrogen selectively, but have only led to niche applications for thick (greater than about 100 μm), self-supporting membranes, involving mainly Pd—Ag alloys. Attempts to make thin, supported, low-cost Pd alloy membranes have encountered problems concerning thermal stability, integrity of the membrane layer, uniformity of the distribution of the alloy constituents, and inter-diffusion between the membrane support and the membrane. Thermal instability issues occur particularly at temperatures greater than about 450° C., during thermal cycling, under high pressure, and for extended operating times. Also, unless they are removed upstream, potential feed contaminants such as hydrogen sulfide, chlorine, carbon monoxide, and hydrocarbons can poison Pd membranes. Development of new Pd alloys continues, e.g. Pd—Cu, where the overall cost is somewhat reduced and the flux is reasonably high.

Group VB metals (V, Nb, and Ta) are a significantly lower cost, high permeability option. However, the Group VB alloys have not yet satisfied many challenging and often conflicting requirements. For example, pure Group VB metals and alloys can embrittle due to the tendency of the hydrogen and other elements to “lock into” interstitial sites. This occurs mostly at low temperature and high pressure. Group VB alloys also expand in hydrogen. Continuous hydrogen dissolution into interstitial sites, discontinuous phase changes, and thermal expansion all contribute to the volume increase. The resulting mechanical instability can destroy the membrane, shorten fatigue life, and require removing hydrogen during a portion of the warm up and cool down cycle. High pressure applications, producing higher concentrations of lattice hydrogen (measured by atomic ratio of hydrogen to metal, H/M), increase volume expansion. Microstructure affects mechanical stability through its effects on factors such as material strength and sintering temperature.

Group VB metals dissolve and diffuse hydrogen better than Pd, leading to higher permeability over a wide temperature range. However, the higher solubility of hydrogen also increases volume expansion and mechanical failure. Alloying additions, used to suppress phase change, hydride formation, and other types of mechanical failures, can reduce permeability. Thus far, only certain alloying additions for Pd, e.g. Ag, Au, and Cu, have been shown to suppress phase change completely above room temperature without compromising permeability.

Group VB alloys are prone to form surface oxides, carbides and nitrides that poison the hydrogen dissociation reaction. Most researchers believe that a Pd coating, as a catalyst and for protection of the alloys, is an inevitable requirement. However, the Pd coating design introduces major stability issues for thin, multi-layer structures having different layer compositions, particularly as temperature increases. The increased reactivity can limit Group VB alloy membrane life to months or less. Group VB alloy reactivity to oxygen and carbon-containing synthesis gas results in surface oxidation, which may occur during fabrication and through operating conditions such as inadequate seals and other system upsets and fouling of the membrane surface by carbon-containing synthesis gas components such as carbon monoxide, carbon dioxide, methane, water, and higher hydrocarbons.

In addition, Group VB alloy reactivity to oxygen and carbon-containing synthesis gas results in dissolution of three types of impurities into interstitial sites, the first group of which involves other transition metals, mainly V, Nb, Ta, W and Mo (˜200 ppm), which can often be tolerated; the second group which involves low-melting point, substitution impurities, which are often removed to less than 10 at-ppm by electron beam float zone melting during fabrication; and the third and most important group of which involves interstitial impurities from the light elements like carbon, nitrogen, and oxygen that strongly influence the properties of the alloys and whose concentrations must be reduced to less than 50 atomic-ppm.

### SUMMARY OF THE INVENTION

It is one object of this invention to provide a multi-layer, metal alloy membrane for selective separation of hydrogen from gaseous mixtures comprising said hydrogen which does not utilize Pd or other noble metal as a component thereof.

It is another object of this invention to provide a selective hydrogen separation membrane utilizing Group VB alloys which addresses known issues as described herein above relating to the use of Group VB metals for hydrogen separation applications.

These and other objects of this invention are addressed by a symmetric multi-layer structure comprising a dense, i.e. substantially nonporous, layer sandwiched between two porous layers and containing no Pd wherein at least 90 atomic % of each layer comprises the same Group VB alloy and wherein the primary or major constituent of the Group VB alloy, which comprises greater than 50 atomic % of the alloy, is a Group VB metal. Preferably, the Group VB alloy is substantially uniformly distributed throughout each layer. However, migration of one or more components of the alloy constituents to the surfaces of the layers due to thermal processing is possible, and such non-homogeneous layer compositions are deemed to be within the scope of this invention. Subsequent reaction of surface material with the feed to form a superficial layer is also possible. Ideally, these superficial layers should be avoided or minimized or kept porous in such a way as to maintain the surface catalytic function of the alloy components at high temperature.

The multi-layer structure of this invention is distinguishable from conventional membranes comprising structural and/or compositional gradients in a single layer in that each layer of the membrane is a separate and distinct layer. Thus, the multi-layer, hydrogen-selective structure of this invention comprises an inner membrane layer comprising at least 90 atomic % of a Group VB alloy and no Pd or other noble metal disposed between two outer membrane support layers comprising at least 90 atomic % of the same Group VB alloy as the inner membrane layer and no Pd or other noble metal. The multi-layer structure is also distinguishable from conventional membranes because there is no requirement of a catalytic or protective coating of the surfaces of the layers. The multi-layer membrane structures of this invention are able to operate at temperatures greater than 400° C. up to about 800° C.

### DETAILED DESCRIPTION OF THE PRESENTLY PREFERRED EMBODIMENTS

The invention disclosed and claimed herein is a symmetrical, multi-layer structure comprising a porous support/dense membrane/porous support configuration in which the same Group VB alloy is used for each of its layers, the amount of the Group VB alloy in each layer is greater than about 90 atomic %, and no Pd or other noble metal is employed in any of the layers of the structure. The use of common support and membrane layer compositions helps to reduce interfacial discontinuities that may develop during the fabrication process. In accordance with one embodiment of this invention, the structure has a planar configuration. In accordance with another embodiment, the structure has a tubular configuration. The symmetrical outer membrane support layers may vary in thickness by up to 25% and differ in both porosity and pore size.

In accordance with one preferred embodiment of this invention, the primary (major) constituent of the Group VB alloy, which constituent comprises at least 50 atomic % of the Group VB alloy, is vanadium (V) because of its relatively low melting point. In accordance with one particularly preferred embodiment, the Group VB alloys are compositions selected from the group of compositions consisting of 1) vanadium and nickel (Ni) and 2) vanadium, nickel, and titanium (Ti).

In accordance with one embodiment of this invention, the dense inner membrane layer is thinner than the outer membrane support layers. In accordance with one preferred embodiment of this invention, the dense inner membrane layer has a thickness in the range of about 0.1 microns to about 100 microns and the outer membrane support layers have a thickness in the range of about 50 microns to about 500 microns.

Deposition fabrication methods require supports with small pore sizes, a high degree of pore size uniformity, and good surface smoothness to achieve a dense membrane layer of the desired thickness. Ceramic supports meet these requirements better than metallic supports. However, the thermal expansion of ceramic supports does not match well with metallic membrane layers. In this invention, the use of tape casting for fabrication of the multi-layer structure removes this surface quality constraint for metallic supports, thereby enabling the use of the same VB alloy for both the support and membrane layers while eliminating inter-diffusion, and improving CTE (coefficient of thermal expansion) match and inter-layer bonding. This design also allows the solid portion of the VB support to contribute to the transportation of hydrogen because it is permeable.

There are at least two procedures by which the multi-layer structure of this invention may be produced—tape casting, lamination, and co-sintering of a porous/dense/porous multi-layer tape, which may have benefits in terms of cost and simplicity, and tape casting of the porous layers onto each side of a commercial VB alloy foil, which may have benefits for the central membrane layer in terms of avoidance of the need to remove slurry components during thermal processing, ensuring the achievement of full density, and avoidance of the formation of a homogeneous alloy composition from separate elemental powders during thermal processing.

In the fabrication process comprising the steps of tape casting, lamination, and co-sintering, each layer of the multi-layer structure is formed by the tape casting of a slurry formulation to form the tape layers. The slurry formulation may start with metal powders, pre-formed metal alloy particles, or some combination thereof. If pre-formed metal alloy powder is not used, it must form homogeneously during thermal processing. Pre-alloying can reduce the thermal processing time to achieve uniform distribution of the alloy and reduce the need for small particle sizes; however, fine alloy powders are often costly to produce and not readily available.

The slurry preferably comprises a high quality Group VB alloy powder having minimal impurity content which closely represents the desired final VB alloy composition of the multi-layer structure, an aqueous and/or non-aqueous solvent to reduce the viscosity sufficiently to cast the slurry, a dispersant to stabilize the powder against colloidal forces, a plastic binder for green layer strength and for enabling removal of the tape from the carrier film onto which the tape is cast without damage, a plasticizer to provide the plasticity of the dry tape, and fugitive pore formers for the porous supports that, along with the particle powder size and sintering conditions, help to achieve the target support porosity upon heating. Minor amounts of metal powder additives, such as Y, Zr, Ti, Cu, Cr, Al, etc. may be employed to stabilize the VB alloy powder against effects such as oxidation, grain growth, surface area loss, creep, altered dimensions, altered pore size distributions, and corrosion by contaminants. The starting powder additives may also comprise metal compounds that decompose to metals and fugitive products during fabrication. Binary oxides, such as CaO, MgO, and TiO₂ in amounts ranging from about 1 wt % to about 5 wt % may also be employed. These oxides do not reduce in the presence of hydrogen, thereby enabling the dispersion, after reduction, of finely dispersed oxide powders in the alloy. The dispersion hardening of the VB alloy may reduce both high temperature creep and dislocation motion, thereby inhibiting shape changes. The solvent is preferably organic, such as alcohol, naphtha, or toluene, which is dried off the tape, resulting in a flexible sheet. Non-aqueous solvents may be useful in dissolving organic binders.

Physical characteristics of the starting Group VB metal or metal alloy powder such as particle size, particle size distribution, and surface area are all factors in determining the amount of binder required, sintering behavior, the sintered porosity/density and microstructure. Small particle sizes and high surface area affect the formation of the dense membrane in which the starting Group VB materials are in powder form as opposed to a membrane layer foil. In contrast thereto, large particle sizes and low surface area promote porosity and prevent pore collapsing in the support layers.

Different processes having different trade-offs may be employed for producing the starting Group VB alloy powders used to fabricate the membrane of this invention. Gas atomization forms powders having small size particles, high purity, and spherical geometry. The low surface area of these particles discourages surface oxidation as well as ingress of oxygen and other contaminants to interstitial sites. By comparison, use of the thermite process, which involves grinding of the resulting VB alloy ingot, produces larger particles sizes (greater than about 45 μm) and less pure powders, but at a much lower cost. Starting powder grain size is preferably in the range of about 0.5-50 μm and operating temperature grain size is in the range of about 0.5-100 μm.

Varying the components of the slurries used in the formation of the different layers may be useful for achieving an optimal multi-layer structure. For example, the use of pore formers in the slurry formulations for the support layers may improve the porosity of the support layers. Layer thicknesses may be varied to effect mechanical strength, mass transport resistance, flux, and sintering temperature.

After formation of the green layers of the multi-layer structure of this invention, the layers are laminated, forming a green, multi-layer tape after the tape has dried. Such lamination may be carried out by co-casting a thin membrane layer with a support layer and then laminating another support layer tape by roll calendering or by roll calendering a laminated, three-layer green tape to reduce the thickness of the layers proportionally. The challenge in thin membrane fabrication is the elimination of pinholes. Thus, the slurry for the thin tapes must be sufficiently fluid for easy removal of bubbles that are a common source of pinholes.

Thereafter, the green multi-layer tape is sintered using, for example, a ceramic muffle within an atmosphere-sintering furnace. Initially, the green multi-layer tape is thermally processed at a temperature of less than about 250° C. so as to remove volatile organic species from the green tape. This step may require the use of a vacuum or inert gas atmosphere to prevent surface oxidation and avoid interstitial ingress of oxygen or hydrogen that could embrittle the alloy. If oxidation does not occur at low temperature or further thermal processing to reverse oxidation is possible, this step may be conducted in air.

After the initial thermal processing, further thermal processing may be conducted in H₂ to fully sinter the center membrane layer and reduce or prevent oxide formation. For V—Ni alloys, the sintering temperature is up to about 1500° C., or about ⅔ the melting temperature of the material. The final density of the center membrane layer should be greater than or equal to about 90% of the theoretical density of the Group VB alloy material. The membrane is then treated in H₂ at a temperature in the range of about 600-1000° C., as needed, to displace remaining interstitial contaminants, complete oxide reduction, minimize other chemical attack, and increase structural integrity by enabling bonding of the oxygen-depleted layers. The common VB alloy support and membrane layer compositions help to eliminate interfacial discontinuities that may develop. The lower melting temperature of vanadium alloys compared with Nb and Ta alloys is beneficial for this process. Oxygen “gettering” procedures may also be used to allow continued absorption of hydrogen along with oxidation avoidance and high temperature H₂ pre-treatment approaches.

As previously indicated, the common composition of the membrane layers facilitates co-sintering as compared, for example, with the co-sintering of dissimilar fuel cell component layers. However, other fabrication methods under development, such a laser reactive deposition (LRD) may also remove the surface dimensional and uniformity constraints of current surface deposition methods.

The co-sintering, tape casting procedure allows for incorporation of both support layers in one step instead of just one side at a time as with current membranes. Differences in thermal expansion among the different layers should be minor due to the similar layer compositions; and having supports on both sides will counteract any differences that may occur (due, for example, to the differences in porosity or minor alloying additions).

One concern is the reactivity of VB alloys, which can result in significant undesirable surface oxidation. Surface oxidation may occur in the starting powders, during fabrication, and through operating conditions such as inadequate seals and other system upsets. Minimizing the effects of oxygen in unprotected VB alloy materials is a substantial challenge. Conventional alloys resist oxidation at high temperatures by alloying with Cr, Al, and/or Si, thereby forming a surface oxide enriched in the less noble alloying elements. If dense and adherent, this oxide or scale inhibits further oxidation. However, hydrogen membranes cannot be permitted to oxidize because an active VB alloy surface is needed for the hydrogen surface reactions.

Solid oxide fuel cell developers routinely control oxide formation by reducing NiO initially present in Ni/YSZ cermet anodes in hydrogen at 600-1000° C. prior to operation of the fuel cell. The reduction of NiO is complete, rapid, and adds needed porosity into the fuel cell anode. However, relatively little is known about controlling vanadium oxidation at high temperature. From a thermodynamic perspective, reduction of vanadium oxide formation would be expected to be more difficult than NiO reduction.

To avoid fouling of the reactive membrane surface by carbon-containing syn-gas components such as CO, CO₂, CH₄, H₂O, and higher hydrocarbons, membranes should be operated at temperatures greater than about 250° C. when CO is present so as to avoid carbon deposition.

As previously indicated, parameters such as porosity, pore size, grain size, and layer thickness all have an impact on the performance of the multi-layer structure of this invention. These parameters affect how completely and rapidly oxide is reduced, how reversible the oxidation that actually occurs is, structural strength, membrane layer integrity, surface area available to catalyze H₂ surface reactions, and the rapidity of H₂ transport to the membrane surface. In accordance with one preferred embodiment, the membrane layer thickness is in the range of about 10-50 μm; support layer thickness is in the range of about 100-500 μm; and porosity of the support layers is greater than about 30 vol %. The structure is open for efficient gas transport and yet suitable for strength to bear thermal and physical stresses. Average pore size is greater than about 1 μm. Fugitive rice-starch, graphite, or other pore formers may be employed for the formation of pores within the support structures.

The powders used in making the slurry formulation may be “activated” to remove surface oxygen by repeated cycling to 400-500° C. in a vacuum. After casting, an individual tape is dried under temperature control. If necessary, despite common layer compositions, slurry formulations for the individual layers may be adjusted to match packing density and sintering shrinkage. The doctor blade opening, which can be controlled using precise doctor blade designs, should be set in anticipation of about a 65% thickness shrinkage upon drying and about a 25% shrinkage upon sintering.

### Tape Formation (Non-Aqueous Solvent)

The basic slurry formulation to cast a metal or metal alloy tape includes a metal or metal alloy powder, non-aqueous solvent, and additives that may include a binder, a plasticizer, and as needed, a dispersant, and a de-foaming agent. The exact amount of these constituents will vary depending on the desired characteristics of the metallic powder. For a high surface area powder that is typically required to obtain a dense, central membrane layer, the formulation range is metallic powder in the range of about 5 to about 15 volume percent, non-aqueous solvent in the range of about 50 to about 90 volume percent, and additives in the range of about 6 to about 35 volume percent. For mixed metals, the solid volume is the sum of all metal volumes. The metal constituents are mixed together in the slurry and do not have to be dry-mixed first. Finer particle sizes for minor constituents in mixed powders provide improved dispersion. Powders that react with water should use an organic-based binder. The solvent is usually a mixture of different compounds such as toluene, acetone, ketone, alcohol, naphtha. The choice of solvent depends on the solubility of the binder and the exact composition is adjusted to yield the optimum drying characteristic for the tape under the selected drying condition. Under slow drying conditions, the fraction of the fast drying solvent is increased and, under fast drying conditions, the fraction of the fast drying solvent may be decreased. Suitable binders includes polyvinyl alcohol (PVA), polyvinyl butyral (PVB), and polyurethane. Suitable additives include polyethylene glycol (PEG, plasticizer), tri-butyl phosphate (dispersant), Sanitizer S-160 (plasticizer, produced by Monsanto), and fish oil (dispersant). The slurry is de-gassed under vacuum.

### Tape Casting Procedure

For the tape casting procedure, all of the slurry ingredients, except the binder, are added to a pint size milling jar containing about 250 g ½-inch ZrO₂ balls and roll milled overnight at a speed of 120 rpm, after which the binder is added to the slurry and roll milled for an additional four (4) hours at 80 rpm. Thereafter, the slurry is degassed and then cast on a Teflon substrate. Good tapes may be produced with doctor blade openings up to about 35 mils. Thicker tapes run the risk of surface cracking due to poor drying. The dry tape thickness may be 26-28% of the casting height.

### Supported Membrane Fabrication Procedure

For the supported membrane fabrication procedure, a membrane layer tape (20-100 μm) is cast with a blade opening allowing for up to 25% shrinkage during drying. After about 2 hrs of drying, a porous layer (˜100-300 μm) is cast over the membrane, again with a blade opening allowing for shrinkage. Another separate tape of the porous layer is cast in the same way. After drying overnight, the bottom sides of each tape are made to face each other and the two tapes are roll laminated together. The organics in the tape are removed either by burning out in air at about 350° C. or using a non-oxidizing atmosphere. The tape is transferred to a H₂ furnace and sintered between porous plates at a temperature in the range of 800 to about 1200° C., starting the H₂ atmosphere above the embrittlement temperature should embrittlement occur. Uniform dispersion to alloy the metallic phases may require prolonged time at temperature. H₂ pre-treatment may be extended as needed to reduce any oxide present and coalesce tape structure. Total thermal processing time is estimated to be 2-15 hours. Periodic heating and cooling may be required during the thermal processing. Fabrication should avoid unacceptable decrease in the porosity of the supports. For a new material composition, the initial sintered samples have to be examined by SEM to verify that the thin membrane is dense and continuous.

### Tape Casting on a Metal Foil (Non-Aqueous Solvent)

In this case, a V-15Ni alloy foil is obtained from a commercial vendor. The foil may be prepared by cleaving an alloy bar formed by melting the alloy components at high temperature in a vacuum or reducing atmosphere. The foil thickness is preferably in the range of about 20 to about 100 μm. Using the slurry formulation discussed herein above, the porous layers are tape cast onto the alloy foil after pre-treating the alloy surfaces to eliminate any oxide present. One porous layer may be tape cast directly onto one side of the foil substrate and then a separately cast porous layer laminated onto the opposite side. Alternatively, three separate layers may be laminated together before co-sintering all layers in one step. The resulting green, multi-layer structure is then sintered as discussed herein above.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A multi-layer hydrogen-selective structure comprising:
a dense inner membrane layer comprising a Group VB alloy and no Pd disposed between two porous outer membrane support layers comprising said Group VB alloy and no Pd or other noble metal, at least 50 atomic % of said Group VB alloy comprising a Group VB metal and at least 90 atomic % of each said layer comprised of said Group VB alloy.

2. The structure of claim 1, wherein said outer membrane support layers have a porosity greater than about 30 vol % of said layers.

3. The structure of claim 1, wherein said outer membrane support layers form pores having a pore size greater than about 1 micron.

4. The structure of claim 1, wherein said outer membrane support layers have a thickness in a range of about 50 microns to about 500 microns.

5. The structure of claim 1, wherein said inner membrane layer has a thickness in a range of about 0.1 microns to about 100 microns.

6. The structure of claim 1, wherein said Group VB alloy comprises V and a metal selected from the group consisting of Ni, Ti, and mixtures and alloys thereof.

7. The structure of claim 1, wherein said layers comprise at least one non-fugitive, functional material.

8. The structure of claim 7, wherein said non-fugitive, functional material is selected from the group consisting of de-oxidants, grain growth inhibitors, surface are loss inhibitors, creep inhibitors, altered dimension inhibitors, surface porosity agents, altered pore size distribution inhibitors, corrosion inhibitors, contaminant resistance inhibitors, and combinations and mixtures thereof.

9. The structure of claim 1, wherein an amount of said VB alloy varies among said layers by less than about 10 atomic %.

10. A membrane material for selective hydrogen separation comprising:
a dense inner membrane layer disposed between two porous outer membrane support layers, at least 90 atomic % of each said layer comprised of a Group VB alloy and no Pd or other noble metal, said Group VB alloy having the same composition for each said layer.

11. The membrane material of claim 10, wherein said outer membrane support layers have a thickness in a range of about 50 microns to about 500 microns.

12. The membrane material of claim 10, wherein said inner layer has a thickness in a range of about 0.1 microns to about 50 microns.

13. The membrane material of claim 10, wherein said Group VB alloy comprises vanadium and a metal selected from the group consisting of Ni, Ti, and mixtures and alloys thereof.

14. The membrane material of claim 10, wherein said layers comprise at least one non-fugitive, functional material.

15. The membrane material of claim 14, wherein said non-fugitive, functional material is selected from the group consisting of de-oxidants, grain growth inhibitors, surface are loss inhibitors, creep inhibitors, altered dimension inhibitors, surface porosity agents, altered pore size distribution inhibitors, corrosion inhibitors, contaminant resistance inhibitors, and combinations and mixtures thereof.

16. In an apparatus for selective hydrogen separation comprising a hydrogen-selective separation membrane, the improvement comprising:
said hydrogen-selective membrane comprising a dense layer disposed between two porous membrane support layers, at least 90 atomic % of each said layer comprising a Group VB alloy and each said layer having no Pd or other noble metal.

17. The apparatus of claim 16, wherein said Group VB alloy comprises vanadium and a metal selected from the group consisting of Ni, Ti, and mixtures and alloys thereof.

18. The apparatus of claim 16, wherein said Group VB alloy layer has a thickness in a range of about 0.1 microns to about 50 microns.

19. The apparatus of claim 16, wherein said membrane support layers have a thickness in a range of about 50 microns to about 500 microns.

20. The apparatus of claim 16, wherein said layers comprise at least one non-fugitive, functional material.

21. The apparatus of claim 20, wherein said non-fugitive, functional material is selected from the group consisting of de-oxidants, grain growth inhibitors, surface are loss inhibitors, creep inhibitors, altered dimension inhibitors, surface porosity agents, altered pore size distribution inhibitors, corrosion inhibitors, contaminant resistance inhibitors, and combinations and mixtures thereof.
